(19) United States
(12) Patent Application Publication
(10) Pub. No.: US 2004/0124995 A1
(43) Pub. Date: Jul. 1, 2004

(54) System for identification of a tire

(76) Inventors: Christoph Treutler, Wannweil (DE); Ralf Schmidt, Gerlingen (DE); Jan Huels, Reutlingen (DE)

Correspondence Address: KENYON & KENYON, ONE BROADWAY, NEW YORK, NY, 10004, US

(21) Appl. No.: 10/654,516

(22) Filed: Sep. 2, 2003

(30) Foreign Application Priority Data
Aug. 31, 2002 (DE) 102 40 244.2

(51) Int. Cl. H04Q 9/00; G08C 19/22

(52) U.S. Cl. 340/870.07

(57) ABSTRACT

A system for identification of a tire on a motor vehicle is proposed, said tire being at least partly equipped with a magnetized material, said system comprising at least one vehicle-mounted reading unit for sensing the magnetized material and a control unit that is connected to the reading unit. The magnetized material represents a magnetic code that is designed in tire-type-specific fashion.

### FIELD OF THE INVENTION

The present invention is based on a system for identification of a tire, and on a tire.

### BACKGROUND INFORMATION

A system with magnetic sensing of a tire is known from German Published Patent Application No. 100 44 287, and serves to detect deformations of the tire while the motor vehicle on which the tire is mounted is being driven. The tire encompasses for that purpose, on its sidewall facing toward the vehicle, a magnetized rubber material that is made of a magnetic powder mixed into the tire rubber and is magnetized along the circumference into North and South poles in alternating segments. When no longitudinal forces are acting on the tires or the vehicle, the changeover between the magnetic poles occurs simultaneously at two sensors offset radially from one another. The time difference between the signals measured at the two sensors is therefore zero. If longitudinal forces are acting on the tire, which is the case in the context of a deceleration or acceleration operation, the boundaries between the magnetic poles pass by the sensors at different points in time, so that the two sensor signals are measured with a time difference. If a corresponding measurement is made on all four tires of the motor vehicle, the longitudinal force ascertained from the time difference offers a potential information source for slip control systems such as an antilock braking system (ABS) and an automatic slip control system (ASR). When cornering, transverse forces act on the tires and vehicle and cause a change in the distance between the sensors and the tire sidewall, thereby once again modifying the magnitude of the measured magnetic field. This measured variable can be utilized, for example, to optimize an antilock braking system and a vehicle dynamics control system.

The system described in German Published Patent Application No. 100 44 287, however, furnishes no information regarding the tire type and the parameters associated therewith.

The identification of vehicle tires has hitherto been accomplished by way of a more or less elevated imprint, or a barcode imprinted on the tire. The imprint or barcode can, however, experience damage as the tire is utilized, so that it can no longer be used for tire identification.

### SUMMARY OF THE INVENTION

The system according to the present invention for identification of a tire of a motor vehicle, in which system the magnetized material represents a magnetic code that is designed in tire-type-specific fashion, has the advantage that a direct transfer of the tire identifier to the associated vehicle during the operation thereof is possible. Errors in the input of a tire type into an antilock braking system or a vehicle dynamics control system during installation of the tire are ruled by the use of the system according to the present invention.

Tire identification using the system according to the present invention is very important especially in terms of vehicle safety and stability systems. With a knowledge of the tire type and the parameters associated therewith, such as dimensions, rubber composition, profile, etc., it is possible to adapt the control routines for an antilock braking system and a vehicle dynamics control system specifically to the tire or tires that is/are installed. The result is a distinct decrease in braking distance in an antilock braking system, and thus a substantial gain in safety. A vehicle dynamics control system can also be adapted specifically to the installed tires by reading in tire parameters, which can result in improved performance in terms of any oversteer or understeer, and in terms of the tipover stability of the motor vehicle.

The magnetic code can be produced in such a way that magnetizable material is added to the basic material of the tire and vulcanized in. At a point in time during production at which the tire will no longer be exposed to elevated temperatures that could result in remagnetization, the code is written in by magnetization in the region of the tire that contains the magnetizable material.

The magnetic code can encompass tire parameters that contain, in standardized form, a complete set of data or parameters for e.g. an antilock braking system and a vehicle dynamics control system for direct further processing in the respectively associated control units, and/or also, for example, an identifier for the standard air pressure of the tire in coded form.

It is also conceivable, however, for the code to contain only a simple tire identifier designating the tire type, and for the associated tire-specific parameters to be stored as an associated data set in the control unit. In this case, when a tire is installed for which no parameters are stored in the control unit, the parameters can be additionally loaded. If such additional loading is not possible, the antilock braking system and/or vehicle dynamics control system, for example, operate on the so-called fallback level with limited performance.

Problems such as the mounting of system elements on or in the tire, signal damping, energy transfer, and microwave stress due to high-frequency signals do not occur with the system according to the present invention. The system can be designed digitally, allowing a high level of fault tolerance to be achieved.

According to an advantageous embodiment of the system according to the present invention, the magnetic code is embodied as a magnetic barcode that, in a simple manner known per se, is written in by magnetization of preferably magnetically hard materials embedded into the tire rubber.

The magnetized material that represents the magnetic code is preferably embedded in a sub-segment of the tire. The sub-segment is preferably located on the sidewall of the tire that faces toward the vehicle. It is also conceivable, however, for the magnetic code additionally or alternatively to be positioned on the wall of the tire forming the running surface of the tire, and/or on the side of the tire that faces away from the vehicle. In particular in order to prevent installation errors, it is advisable to apply the coding to both sidewalls of the tire.

The magnetic code can encompass several code strips. The individual code strips can contain either identical or different parameters. Code strips that contain identical parameters are preferably positioned one behind another in the circumferential direction, and are associated with a reading unit so that a means for error compensation is available in the event of nonuniform rotation of the tire. In such a case, the time between initial motion of the relevant vehicle and transfer of the tire parameters stored in the tire to the reading unit is also minimized.

In the context of nonuniform rotations of the tire, such as can occur as a motor vehicle moves off from a standstill, the reading unit furnishes a signal that is nonuniform over time. With small data volumes and a corresponding error-tolerant code, it may be sufficient to provide one reading unit per code strip and otherwise no further actions. Distortion is then corrected, for example, using the assumption of a linear profile, by defining the beginning and ending times of the code transmission.

In order to allow the magnetic code to be dealt with reliably in the context of nonuniform rotation of the tire, however, a so-called timing strip can be provided. The timing strip is preferably also made up of a magnetic barcode whose magnetization encompasses equidistantly positioned North and South poles. It thus has a permanently defined magnetization pattern that can be simultaneously measured along with the code strips by means of a reading unit. The timing strip, which preferably is positioned concentrically with the code strip, ensures that by the use of the timing function, the measured signals can be corrected for distortion and correctly allocated.

The reading unit is preferably embodied with at least one active magnetic field sensor. A magnetic field sensor can be associated with each code strip or timing strip integrated onto the tire.

Distortion correction of the signals by way of a pattern comparison for each time unit with a high error tolerance is also possible if the system encompasses two magnetic field sensors that are positioned at a defined distance one behind another in the circumferential direction of the tire, and are associated with one and the same code strip. It is then possible to dispense with separate timing by means of an additional timing strip, since the distortion due to nonuniform motions can be eliminated by comparing the patterns measured at the two sensors and their offset in time. Correspondingly, as already mentioned above, two identical code strips can be associated with one reading unit or one magnetic field sensor.

For code strips or timing strips offset radially from one another, the reading unit encompasses at least two magnetic field sensors offset radially from each other. Distortion correction of the measured signals can be accomplished, for example, by means of two magnetic field sensors that are associated with one of the code strips.

The magnetic field sensor can operate, for example, on the Hall principle or the XMR principle, in particular the AMR or GMR principle. For high resolution and large working distances between the code strips and the magnetic field sensor, an embodiment of the magnetic field sensor using the GMR (giant magnetoresistance) principle is also particularly suitable. After extraction by means of a correspondingly embodied magnetic field sensor, the information stored in coded form in the tire is available for the relevant control units, e.g. those for an antilock braking system, a vehicle dynamics control system, and optionally also for a tire pressure monitoring system present in the vehicle.

The barcode magnetized onto the tire corresponds substantially to a change in the North-South polarization, and is thus very similar to a magnet wheel. For this reason, a so-called gradiometer assemblage is possibly suitable for the magnetic field sensor itself. To allow large working distances between the reading unit and the code strip to be achieved, it is advisable to use the magnetic field sensor operating on the GMR principle. With a sensor of this kind, for example, a barcode having a North-South-North alternation cycle of 5 mm can still be reliably resolved at a distance of up to 8 mm. For larger alternation cycles, the working distance also increases correspondingly. With a North-South-North alternation cycle of approximately 11 mm, for example, a distance of 16 mm can be provided between the magnetic field sensor and the tire.

Depending on the design of the system according to the present invention, the magnetic code can be read in by means of the reading unit each time the motor vehicle is put into operation, and/or also each time the motor vehicle moves off from a standstill, e.g. over the first five meters of travel.

In addition, the system according to the present invention can be provided with a shop unit or handheld unit for reading out the magnetic code, by means of which it is possible, for example in the event of a failure of the vehicle-mounted reading unit, to read the magnetic code into the reading unit.

In order to ensure a high level of error tolerance in the system according to the present invention, it is possible to proceed by setting threshold values using digital signals that indicate only the magnetization direction of the barcode bar.

The present invention also has as its subject matter a tire of a motor vehicle that at least locally encompasses a magnetized material. According to the present invention, the magnetized material represents a magnetized code that is designed in tire-type-specific fashion. Such a code is not subject to wear.

### BRIEF DESCRIPTION OF THE DRAWINGS

FIG. 1 shows a schematic sketch of a system according to the present invention for identification of a tire, depicting a tire with its running surface.

FIG. 2 shows the system depicted in FIG. 1, the tire being depicted with its sidewall.

FIG. 3 shows a tire having a code segment positioned in a tire segment.

FIG. 4 shows a tire having three code segments.

FIG. 5 shows a highly schematic depiction of a code strip of a tire, shown in isolation.

FIG. 6 shows a code strip having a timing strip.

FIG. 7 shows the code strip of FIG. 6 in a context of nonuniform or accelerated motion of the tire.

FIG. 8 shows a system having two code strips and one timing strip.

### DETAILED DESCRIPTION

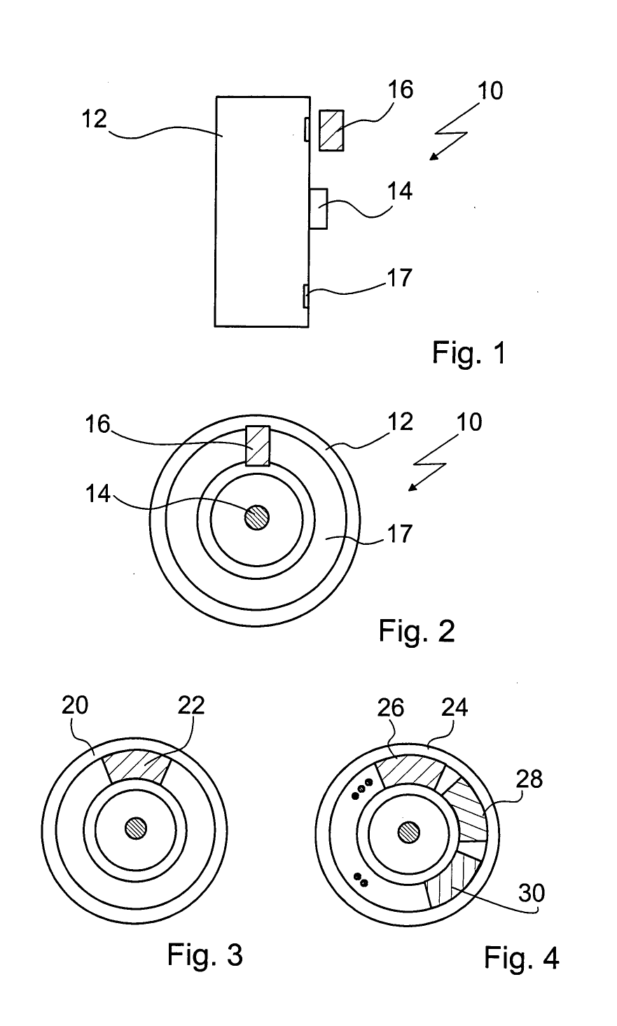

FIGS. 1 and 2 depict a system 10 for identification of a tire type on a motor vehicle. System 10 encompasses a tire 12 which is mounted on a wheel suspension 14 (depicted here in highly simplified fashion) that constitutes a rotation axis for tire 12.

Tire 12 has, on its sidewall facing toward the motor vehicle, an annular region 17 that encompasses a magnetically hard material which represents a magnetic code. The magnetic code is designed in tire-type-specific fashion and is embodied as a magnetic barcode. The magnetic code encompasses, in the present case, tire parameters of tire 12 such as its dimensions, rubber composition, profile, and required tire pressure.

In order to read in the magnetic code and tire parameters that are stored in region 17 in the form of the magnetic barcode, system 10 encompasses a reading unit 16, known per se, that has a magnetic field sensor which operates, for example, on the GMR principle and is connected to a control unit (not depicted here in further detail). In the embodiment shown, the distance between reading unit 16 and region 16 of tire 12 having the code is approximately 8 mm.

FIG. 3 depicts a tire 20 that, corresponding to the tire depicted in FIG. 2, has a barcode 22 which is embodied here in the form of a magnetized segment which forms an arc that follows the curvature of tire 20. Barcode 22 is positioned on the side of tire 20 facing toward the vehicle, and coacts with a magnetic field sensor of a reading unit of the kind depicted in FIGS. 1 and 2.

FIG. 4 depicts a tire 24 that differs from the tire shown in FIG. 3 in that it has three code segments 26, 28, and 30 that are positioned, one behind another in the circumferential direction, on the wall of tire 24 facing toward the vehicle. The three coding segments 26, 28, and 30 are also each embodied as a magnetic barcode that contains tire-specific parameters and coacts with a reading unit of the kind depicted in FIGS. 1 and 2. The code segments can each contain different tire-specific data, or can also be identical so as to ensure, by way of their repetition, rapid readout of the data e.g. after the motor vehicle has moved off from a standstill.

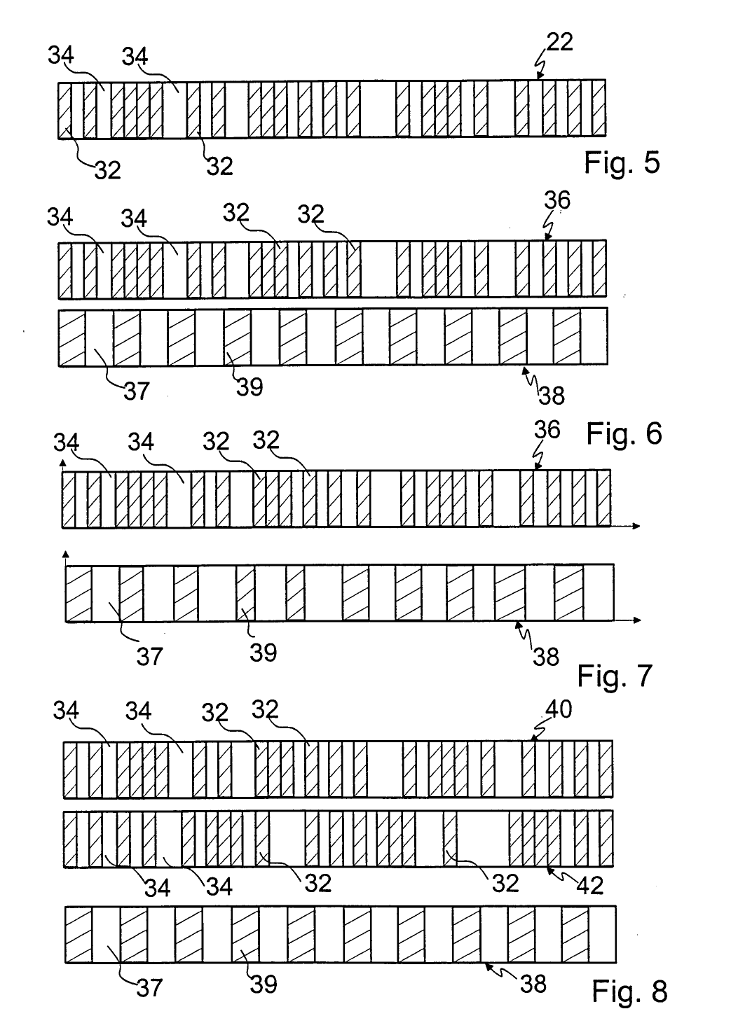

FIG. 5 shows in more detail a code strip, or code segment 22, of tire 20 of FIG. 3 in a depiction that, for the sake of clarity, is linear and not curved. Code strip 22 here encompasses strips 32 depicted with crosshatching that are polarized as North, and strips 34 depicted without crosshatching that are polarized as South. By way of the distance and the width of the individual strips 32 and 34 and the North-South-North alternation cycle, tire-specific parameters can be read into the control unit of the motor vehicle by being read out by means of reading unit 16, and by evaluation by way of an evaluation unit associated therewith.

FIGS. 6 and 7 depict a code strip 36 that corresponds to the one shown in FIG. 5 but, in order to correct distortions from nonuniform rotations of the associated tire, is correlated with a timing strip 38 that encompasses south poles 37 and north poles 39 positioned equidistantly.

The signal sequence of the two strips 36 and 38 constituting the code segment, in the context of a nonuniform (e.g. accelerated) motion of the associated tire, is depicted in highly schematic fashion in FIG. 7. A computational distortion correction of the signals measured by means of the reading unit is possible by means of timing strip 38 and its poles 37 and 39, since each pole 37, 39 of timing strip 38 has a specific position on the code strip associated with it, and distortions of the signals depicted by way of example in FIG. 7 can thus be calculated by way of the timing cycle. A separate magnetic field sensor is provided for timing strip 38.

FIG. 8 depicts a code segment of a tire which differs from the one shown in FIG. 6 in that it has two code strips 40 and 42, so that a plurality of tire-specific parameters can be stored in coded form in the associated tire. In order to correct distortions of the measured signals in the context of nonuniform motion of the tire, the system according to FIG. 8 also has a timing strip 38. A separate magnetic field sensor is associated with each of strips 40, 42, and 38.

what is claimed is:

1. A system for identifying a tire on a motor vehicle, the tire being at least partly equipped with a magnetized material, the system comprising:
at least one reading unit capable of being mounted on the motor vehicle and for sensing the magnetized material; and
a control unit that is connected to the at least one reading unit, wherein:
the magnetized material represents a magnetic code that is designed in tire-type-specific fashion.

2. The system as recited in claim 1, wherein:
the magnetic code is embodied as a magnetic barcode.

3. The system as recited in claim 1, wherein:
the magnetic code encompasses a tire parameter.

4. The system as recited in one of claim 1, wherein:
the magnetized material is capable of being embedded in a sub-segment of the tire.

5. The system as recited in claim 1, wherein:
the magnetic code is capable of being embedded in at least one sidewall of the tire.

6. The system as recited in claim 1, wherein:
the magnetic code includes at least one code segment having at least one code strip.

7. The system as recited in claim 1, wherein:
the magnetic code includes a magnetic timing strip associated therewith.

8. The system as recited in claim 1, further comprising:
multiple code strips positioned concentrically.

9. The system as recited in claim 1, further comprising:
multiple code segments capable of being positioned one behind another in a circumferential direction of the tire.

10. The system as recited in claim 1, wherein:
the at least one reading unit includes at least one active magnetic field sensor.

11. The system as recited in claim 1, wherein:
the at least one reading unit includes a plurality of magnetic field sensors capable of being positioned one behind another in a circumferential direction of the tire.

12. The system as recited in claim 1, wherein:
the at least one reading unit includes at least two magnetic field sensors offset radially from each other.

13. The system as recited in claim 10, wherein:
the at least one active magnetic field sensor operates on one of the Hall principle and the XMR principle.

14. The system as recited in claim 1, wherein:
parameter sets for different tire types are stored in the control unit.

15. The system as recited in claim 1, wherein:
a reading-in of the magnetic code is performed by the at least one reading unit each time the motor vehicle is put into operation.

16. The system as recited in one of claim 1, wherein:
a reading-in of the magnetic code is performed each time the motor vehicle moves off from a standstill.

17. The system as recited in claim 1, further comprising:
a handheld unit for reading out the magnetic code.

18. A tire of a motor vehicle, comprising:
a magnetized material encompassed at least locally, wherein:
the magnetized material represents a magnetized code that is designed in tire-type-specific fashion.
